(19) United States
(12) Patent Application Publication
(10) Pub. No.: US 2014/0095223 A1
(43) Pub. Date: Apr. 3, 2014

(54) THREE-DIMENSIONAL INTERACTIVE SEAT MAP

(71) Applicants: Oliver Oxenham, San Mateo, CA (US); Wesley Oxenham, San Francisco, CA (US); Jennifer Sylva, San Francisco, CA (US); Matthew Scott Zises, San Jose, CA (US)

(72) Inventors: Oliver Oxenham, San Mateo, CA (US); Wesley Oxenham, San Francisco, CA (US); Jennifer Sylva, San Francisco, CA (US); Matthew Scott Zises, San Jose, CA (US)

(21) Appl. No.: 14/039,933

(22) Filed: Sep. 27, 2013

Related U.S. Application Data
(60) Provisional application No. 61/707,815, filed on Sep. 28, 2012.

(51) Int. Cl. G06Q 10/02

(52) U.S. Cl. CPC G06Q 10/02
USPC 705/5

(57) ABSTRACT

Computing systems and methods for facilitating the review and purchase of tickets for ticketed events include memory devices or storage components that store event information regarding upcoming ticketed events and venue information for seating arrangements and views from seats, as well as one or more processors for conducting activities regarding the review and purchase of tickets using a three-dimensional interactive seat map. Activities include providing a display on a computing device including information regarding a venue that is used for ticketed events, accepting on the computing device an input from the user regarding seating arrangements for the venue, determining an attendance location for a ticketed event at the venue based upon the first input, generating a virtual three-dimensional or augmented reality view of a region of interest at the venue from the determined attendance location, and displaying to the user the virtual three-dimensional or augmented reality view.

### CROSS REFERENCE TO RELATED APPLICATION

The present application claims priority to U.S. Provisional Patent Appl. Ser. No. 61/707,815, filed Sep. 28, 2012 which is incorporated by reference in its entirety.

### TECHNICAL FIELD

The present disclosure relates generally to electronic commerce, and more particularly to the presentation of seating arrangements associated with automated ticket transactions.

### BACKGROUND

Computer systems and networks have facilitated the tasks of buying, selling and transferring goods. For example, global computer networks, such as the Internet, have allowed purchasers to relatively quickly and efficiently seek and purchase goods online. Similarly, global computer networks provide an efficient and cost-effective medium for sellers to advertise, offer, provide, and sell their goods. Electronic commerce companies provide buyers and sellers with online services and the infrastructure to accept orders of goods from remote purchasers, to perform the financial transactions necessary to confirm and complete the sale of goods, to ship or distribute the goods to remote purchasers, and to perform other related logistics.

One example of a market for goods within the realm of electronic commerce is the online ticket. Many different websites and parties buy, sell and provide marketplaces for tickets online, and the ability for individuals to buy and sell tickets online is now generally well known. These tickets can be for a variety of live events, such as, for example, sports, concerts, theater, and other entertainment events. In many instances, a buyer looks for available tickets on a ticket marketplace or other online listing and decides which, if any, of the available tickets are of interest to the buyer for possible purchase. The buyer can be provided with information such as an event date and time, venue, the price of the tickets, prices of closed listings (both sold and unsold), and location of the tickets, such as through a seating chart of the venue. Based on these and possibly other informational items, the user can select desired tickets from among multiple listings at the same website or online presence.

Unfortunately, such ticket selections can be based on limited information, which may result in the buyer purchasing a ticket or tickets that are not optimized as being the “best” for that buyer given the desired circumstances of that buyer. For example, a given buyer might be willing to pay a little more for seats at another venue location having a different perspective of the event, or having added perks such as special club or concessions access. Other features such as benches, wider chairs, padded seats, usher service and the like might also be appealing to some purchasers, where such items might vary from one location to another at the venue or event.

Although many systems and methods for purchasing tickets and attending ticketed events in groups have generally worked well in the past, there is always a desire for improvement. In particular, what is desired are systems and methods that provide potential ticket purchasers with a more intelligent and informed way to select and purchase tickets to various ticketed events.

### BRIEF DESCRIPTION OF THE DRAWINGS

The included drawings are for illustrative purposes and serve only to provide examples of possible systems and methods for the disclosed three-dimensional interactive seat maps, such as for use in the purchase of tickets to various ticketed events. These drawings in no way limit any changes in form and detail that may be made to that which is disclosed by one skilled in the art without departing from the spirit and scope of this disclosure.

FIG. 1 illustrates in block diagram format an exemplary computing system adapted for implementing one or more processes involving the organization of group attended ticketed events according to one embodiment of the present invention.

FIG. 2 illustrates in block diagram format an exemplary computer system suitable for implementing on one or more devices of the computing system in FIG. 1 according to one embodiment of the present invention.

FIGS. 3A-3B illustrate screenshots of exemplary service provider pages depicting overhead graphical representations of venues for ticketed event of interest according one embodiment of the present invention.

FIGS. 4A-4B illustrate screenshots of exemplary service provider pages depicting three-dimensional graphical representations of venues from particular seats for ticketed event of interests according to one embodiment of the present invention.

FIGS. 5A-5F illustrate screenshots of exemplary service provider pages depicting graphical representations using Google Earth of a video progression of showing a selected venue and various seat views therefrom for ticketed event of interests according to one embodiment of the present invention.

FIG. 6 illustrates screenshots of exemplary service provider pages depicting a progression for selecting tickets and displaying seat views for the selected seats for a ticketed event according to one embodiment of the present invention.

FIG. 7A illustrates screenshots of exemplary service provider pages depicting graphical representations of selected seats from overhead map and virtual three-dimensional views for ticketed event of interests according to one embodiment of the present invention.

FIG. 7B illustrates a screenshot of an exemplary service provider page depicting a graphical representations of a venue and locations of friends or known persons at that venue according to one embodiment of the present invention.

FIGS. 7C-7D illustrate representations of mobile devices depicting various screenshots of exemplary service provider pages that utilize map and virtual three-dimensional views according to one embodiment of the present invention.

FIG. 8 provides a flowchart of an exemplary method of facilitating a ticket selection for a ticketed event using a three-dimensional interactive seat map according to one embodiment of the present invention.

### DETAILED DESCRIPTION

Exemplary applications of apparatuses and methods according to the present invention are described in this section. These examples are being provided solely to add context and aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible, such that the following examples should not be taken as limiting.

In the following detailed description, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting, such that other embodiments may be used, and changes may be made without departing from the spirit and scope of the invention.

The present invention relates in various embodiments to devices, systems and methods involving activities with respect to the online purchase of tickets to ticketed events. In various particular embodiments, the subject devices, systems or methods can involve one or more user devices in communication over a network. Such a network can facilitate the improved discovery, perusal and purchase of tickets online, such as through the use of a three-dimensional interactive seat map.

While the various examples disclosed herein focus on particular aspects regarding the purchase of tickets, it will be understood that the various inventive principles and embodiments disclosed herein can be applied to other types of ticketed applications and arrangements as well. For example, a ticket purchase done in person or on a closed or proprietary computing system may utilize one or more of the aspects and features found in the various systems and methods provided.

### Systems and Devices

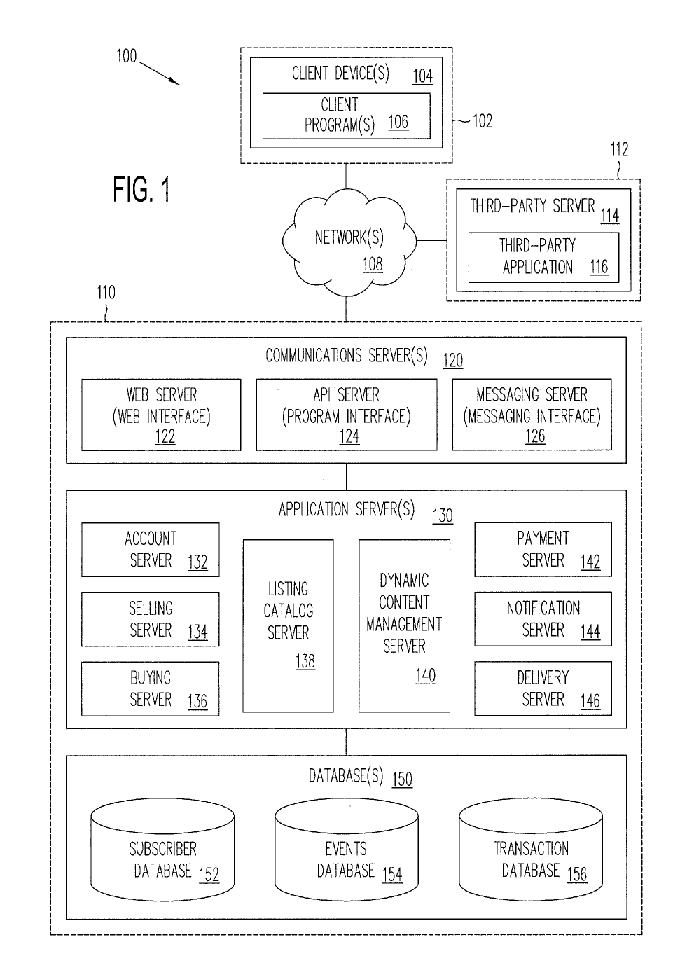

Beginning with FIG. 1, an exemplary embodiment of a computing system adapted for implementing one or more processes involving the organization of group attended ticketed events is illustrated in block diagram format. As shown, computing system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. I may be deployed in other ways and that the operations performed and/or the services provided by such servers may be combined or separated for a given implementation and may be performed by a greater number or fewer number of servers. One or more servers may be operated and/or maintained by the same or different entities.

Computing system 100 can include, among various devices, servers, databases and other elements, a client 102 that may comprise or employ one or more client devices 104, such as a mobile computing device, a PC, and/or any other computing device having computing and/or communications capabilities in accordance with the described embodiments. Client devices 104 generally may provide one or more client programs 106, such as system programs and application programs to perform various computing and/or communications operations. Exemplary system programs may include, without limitation, an operating system (e.g., MICROSOFT® OS, UNIX® OS, LINUX® OS, Symbian OS™, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Exemplary application programs may include, without limitation, a web browser application, messaging applications (e.g., e-mail, IM, SMS, MMS, telephone, voicemail, VoIP, video messaging), contacts application, calendar application, electronic document application, database application, media application (e.g., music, video, television), location-based services (LBS) application (e.g., GPS, mapping, directions, point-of-interest, locator), and so forth. One or more of client programs 106 may display various graphical user interfaces (GUIs) to present information to and/or receive information from one or more of client devices 104.

As shown, client 102 can be communicatively coupled via one or more networks 108 to a network-based system 110. Network-based system 110 may be structured, arranged, and/or configured to allow client 102 to establish one or more communication sessions with network-based system 110 using various computing devices 104 and/or client programs 106. Accordingly, a communication session between client 102 and network-based system 110 may involve the unidirectional and/or bidirectional exchange of information and may occur over one or more types of networks 108 depending on the mode of communication. While the embodiment of FIG. 1 illustrates a computing system 100 deployed in a client-server operating environment, it is to be understood that other suitable operating environments and/or architectures may be used in accordance with the described embodiments.

Data and/or voice communications between client 102 and the network-based system 110 may be sent and received over one or more networks 108 such as the Internet, a WAN, a WWAN, a WLAN, a mobile telephone network, a landline telephone network, a VoIP network, as well as other suitable networks. For example, client 102 may communicate with network-based system 110 over the Internet or other suitable WAN by sending and or receiving information via interaction with a web site, e-mail, IM session, and/or video messaging session. Any of a wide variety of suitable communication types between client 102 and system 110 can take place, as will be readily appreciated.

In various embodiments, computing system 100 can include, among other elements, a third party 112, which may comprise or employ a third-party server 114 hosting a third-party application 116. In various implementations, third-party server 314 and/or third-party application 116 may host a web site associated with or employed by a third party 112. For example, third-party server 114 and/or third-party application 116 may enable network-based system 110 to provide client 102 with additional services and/or information, such as additional ticket inventory. In some embodiments, one or more of client programs 106 may be used to access network-based system 110 via third party 112. For example, client 102 may use a web client to access and/or receive content from network-based system 110 after initially communicating with a web site of third-party 112.

Network-based system 110 may comprise one or more communication servers 120 to provide suitable interfaces that enable communication using various modes of communication and/or via one or more networks 108. Communication servers 120 can include a web server 122, an API server 124, and/or a messaging server 126 to provide interfaces to one or more application servers 130. Application servers 130 of network-based system 110 may be structured, arranged, and/or configured to provide various online marketplace and/or ticket fulfillment services to users that access network-based system 110. In various embodiments, client 102 may communicate with application servers 130 of network-based system 110 via one or more of a web interface provided by web server 122, a programmatic interface provided by API server 124, and/or a messaging interface provided by messaging server 126. It can be appreciated that web server 122, API server 124, and messaging server 126 may be structured, arranged, and/or configured to communicate with various types of client devices 104 and/or client programs 106 and may interoperate with each other in some implementations.

Web server 122 may be arranged to communicate with web clients and/or applications such as a web browser, web browser toolbar, desktop widget, mobile widget, web-based application, web-based interpreter, virtual machine, and so forth. API server 124 may be arranged to communicate with various client programs 106 and/or a third-party application 116 comprising an implementation of API for network-based system 110. Messaging server 126 may be arranged to communicate with various messaging clients and/or applications such as e-mail, IM, SMS, MMS, telephone, VoIP, video messaging, and so forth, and messaging server 126 may provide a messaging interface to enable access by client 102 and/or third party 112 to the various services and functions provided by application servers 130.

When implemented as an online ticket marketplace, application servers 130 of network-based system 110 may provide various online marketplace and ticket fulfillment services including, for example, account services, buying services, selling services, listing catalog services, dynamic content management services, delivery services, payment services, and notification services. Application servers 130 may include an account server 132, a buying server 134, a selling server 136, a listing catalog server 138, a dynamic content management server 140, a payment server 142, a notification server 144, and/or a delivery server 146 structured and arranged to provide such online marketplace and ticket fulfillment services.

Application servers 130, in turn, may be coupled to and capable of accessing one or more databases 150 including a subscriber database 152, an active events database 154, and/or a transaction database 156. Databases 150 generally may store and maintain various types of information for use by application servers 130 and may comprise or be implemented by various types of computer storage devices (e.g., servers, memory) and/or database structures (e.g., relational, object-oriented, hierarchical, dimensional, network) in accordance with the described embodiments. Further details regarding the various components, capabilities and features of computing system 100 can be found at, for example, U.S. patent application Ser. No. 13/293,854, entitled “Intelligent Seat Recommendation,” filed on Nov. 10, 2011, which is incorporated herein by reference in its entirety.

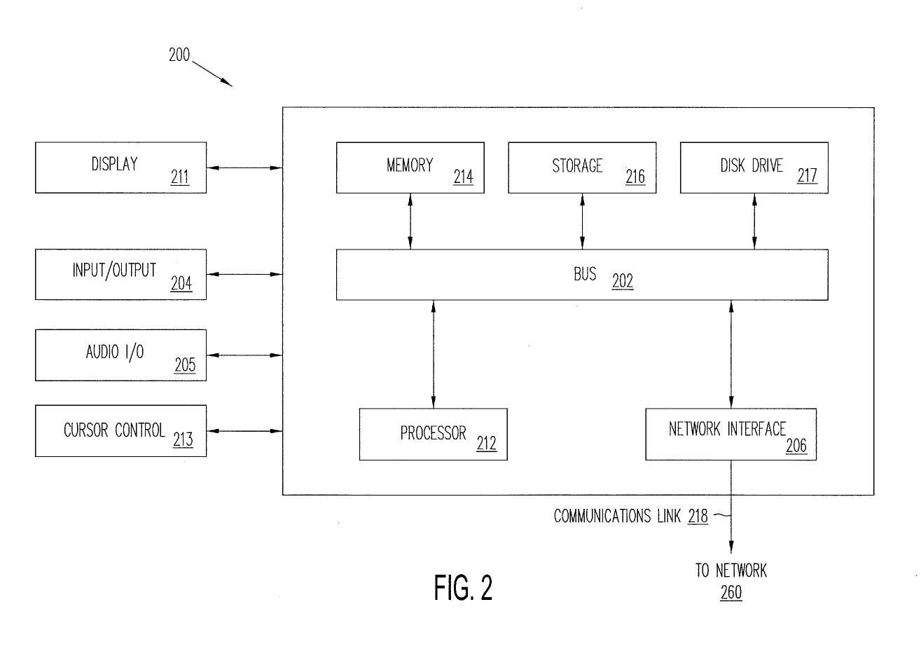

Continuing with FIG. 2, an exemplary computer system 200 suitable for implementing on one or more devices of the computing system in FIG. 1 is depicted in block diagram format. In various implementations, a device that includes computer system 200 may comprise a personal computing device (e.g., a smart phone, a computing tablet, a personal computer, laptop, PDA, Bluetooth device, key FOB, badge, etc.) that is capable of communicating with a network. The ticket provider and/or a payment provider may utilize a network computing device (e.g., a network server) capable of communicating with the network. It should be appreciated that each of the devices utilized by users, ticket providers, and payment providers may be implemented as computer system 200 in a manner as follows.

Computer system 200 can include a bus 202 or other communication mechanism for communicating information data, signals, and information between various components of computer system 200. Components include an input/output (I/O) component 204 that processes a user action, such as selecting keys from a keypad/keyboard, selecting one or more buttons or links, etc., and sends a corresponding signal to bus 202. I/O component 204 may also include an output component, such as a display 211 and a cursor control 213 (such as a keyboard, keypad, mouse, etc.). An optional audio input/output component 205 may also be included to allow a user to use voice for inputting information by converting audio signals. Audio I/O component 205 may allow the user to hear audio. A transceiver or network interface 206 transmits and receives signals between computer system 200 and other devices, such as another user device, a merchant server, or a payment provider server via a network. In one embodiment, the transmission is wireless, although other transmission mediums and methods may also be suitable. A processor 212, which can be a micro-controller, digital signal processor (DSP), or other processing component, processes these various signals, such as for display on computer system 200 or transmission to other devices over a network 260 via a communication link 218. Processor 212 may also control transmission of information, such as cookies or IP addresses, to other devices.

Components of computer system 200 also include a system memory component 214 (e.g., RAM), a static storage component 216 (e.g., ROM), and/or a disk drive 217. Computer system 200 performs specific operations by processor 212 and other components by executing one or more sequences of instructions contained in system memory component 214. Logic may be encoded in a computer readable medium, which may refer to any medium that participates in providing instructions to processor 212 for execution. Such a medium may take many forms, including but not limited to, non-volatile media, volatile media, and transmission media. In various implementations, non-volatile media includes optical or magnetic disks, volatile media includes dynamic memory, such as system memory component 214, and transmission media includes coaxial cables, copper wire, and fiber optics, including wires that comprise bus 202. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 200. In various other embodiments of the present disclosure, a plurality of computer systems 200 coupled by communication link 218 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise.

### Interactive Seat Map

As will be readily appreciated, the foregoing networks, systems, devices, methods and variations thereof can be used to implement the improved selection and purchase of tickets in a more informed and intelligent fashion. Rather than having users resort to known procedures involving the selection and purchase of tickets, a more user friendly system having a robust user interface and process involving the use of an interactive map using virtual three-dimensional or augmented reality views can be provided. In various embodiments, a ticket selection and purchase using an interactive seat map can be facilitated by an online service provider, such as, for example, StubHub, Inc. of San Francisco, Calif..

In various embodiments, ticketed events can be social or recreational events, such as concerts and sporting events. Alternatively such events can be business related events, such as business meetings, conferences, retreats, and the like. In various embodiments, one or more networks, systems, devices and methods that assist users in selecting and purchasing tickets using an interactive virtual three-dimensional or augmented reality seat map can involve specialized hardware and/or computer programs. Such hardware and/or programs can be located on user devices, on system servers, and/or distributed across an overall network.

Available tickets, sections and/or price ranges can be obtained or provided to the user by way of structured data from the service provider and/or other sources. Such data can be presented to the user in a manner so as to readily facilitate the selection and purchase of tickets with respect to preferred sections, seats, concessions and/or pricing options that may be suitable. Such section or pricing options can be variable or varied depending upon the number of tickets desired and preferred section or pricing parameters.

One way to facilitate providing users with information to make more intelligent and informed way to select and purchase tickets to various ticketed events can involve providing an interactive three-dimensional interactive seat map. Such a seat map or interface can be three-dimensional, involve augmented reality, or both. This interactive three-dimensional (3D) seat map for a venue can be created using 3GS, 4GS, HTML5, or any other suitable mapping language or protocol. Such a 3D map can be used in conjunction with a 2D map to show sections and rows around the venue in a more effective manner. Toggling back and forth between the 2D and the 3D maps can then take place when a user desires to see what the view looks like from a particular seating location on a simpler but more distributed 2D map.

In various embodiments, a user can access the interactive seat map or interface from any suitable remote location with any suitable computer or device. Such remote access can involve taking a virtual “walk” around the venue, seeing available seats and prices at different places along the walk, and possibly purchasing one or more tickets after seeing the view from each seat or other attendance location of interest. In some embodiments, a user can access the interactive seat map or interface while he or she is physically present at or near the venue. This can allow a user to see virtually what the view looks like “over there” at a different attendance location, and can even allow the user to see what the virtual views look like from the exact location of the user.

When a user is at a given venue, the user can be permitted to use a smart phone, tablet, laptop computer or other portable device to access the interactive seat map. In addition to seeing different views from different locations at the venue, the user could also purchase seats for future events or concessions. In some embodiments, a user can compare views from different seats and select one or more seats for one or more ticketed events, either physically at the venue or virtually through the portable computing device of the user.

In various embodiments, this can involve the user purchasing tickets for a given seat or other attendance location right at the exact seat or attendance location. This can involve the use of GPS, triangulation or other specific location services. For example, a user having a smart phone can physically walk about a venue, whereby the system will track the location of the user by way of the smart phone. In this manner, the user can be certain of the exact location and/or view of tickets that he or she is purchasing or otherwise expressing an interest. This can relieve some users of the need to manually determine a section, row and seat number for their exact location upon purchase or inquiry.

In the event that no tickets are available for a given seat at a given future ticketed event, or where the user may just wish to know when a particular seat or seats are available for purchase for any future event, the user can be provided with an option to express an interest in the particular seat(s). For example, where seats in Row 20 of Section 125 are not available for any future games, but the user would really like to watch a game from that particular location, the user can indicate that they would like to be notified whenever tickets for that row do go on sale or are otherwise made available.

As noted with respect to FIG. 2 above, a computer system 200 can include one or more processors 212 and one or more memories or storage devices 214, 216. Such a computer system 200 can be part of a user device, part of one or more servers on a network-bases system, or some combination thereof. In particular, a given computing system can include one or more memory devices or storage components 214, 216 adapted to store event information regarding one or more upcoming ticketed events, as well as venue information regarding seating arrangements and views from seats. In addition, one or more processors 212 can be in communication with the one or more memory devices or storage components and can be adapted to facilitate providing a display on a computing device to a user thereof, the display including information regarding a venue that is used for one or more ticketed events,

Further functionality of the one or more processors 212 can include the ability to accept on the computing device a first input from the user regarding seating arrangements for the venue, determine a first attendance location for a ticketed event at the venue based upon the first input, generate a first virtual three-dimensional or augmented reality view of a region of interest at the venue from the determined first attendance location, and display to the user the first virtual three-dimensional or augmented reality view. The first virtual three-dimensional or augmented reality view can be displayed on the same display component that displays the information regarding the venue. In various embodiments, the computing system can also include a display component adapted to display to the user the first virtual three-dimensional or augmented reality view. Further, the attendance location can be a specific seat at the venue selected by the user, such as while the user is physically at the selected seat.

In various embodiments, the one or more processors are further adapted to accept a request to purchase tickets to the ticketed event from the user, where the request is based at least in part on the display of the first virtual three-dimensional or augmented reality view. In addition, the one or more processors can be further adapted to accept a second input from the user indicating a user interest in the determined first attendance location, and send a communication to the user at a later time when tickets at or near the determined first attendance location become available for purchase for another ticketed event at the venue.

In still further embodiments, the processor(s) are further adapted to accept a second input from the user regarding alternative seating arrangements for the venue, determine a second attendance location for the ticketed event at the venue based upon the second input, generate a second virtual three-dimensional or augmented reality view of the region of interest at the venue from the determined second attendance location, and display to the user the second virtual three-dimensional or augmented reality view. Such displaying can involve a virtual reality transition from the first to the second virtual views, such as a movie-like or video transition.

Various screenshots of exemplary pages from a potential service provider having an interactive 3D seat map will now be provided for purposes of illustration. It will be understood that such screenshots and pages are not intended to be limiting, and that these merely provide examples of what such pages may contain. Furthermore, not every noted page need be provided for a given service provider, and additional pages not shown or described might also be included in some instances.

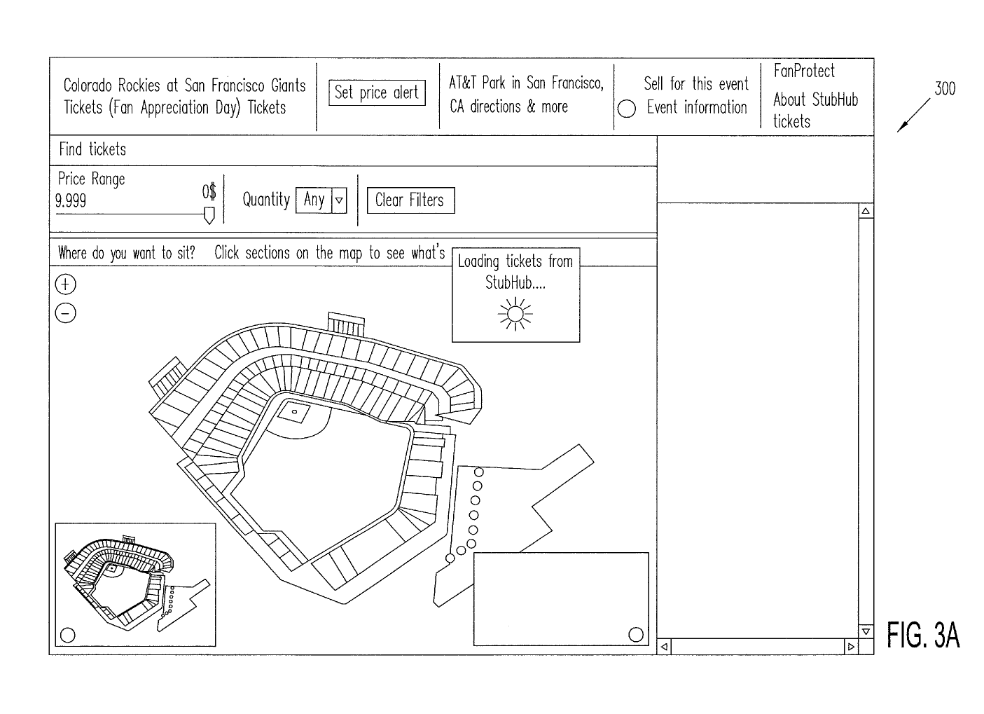

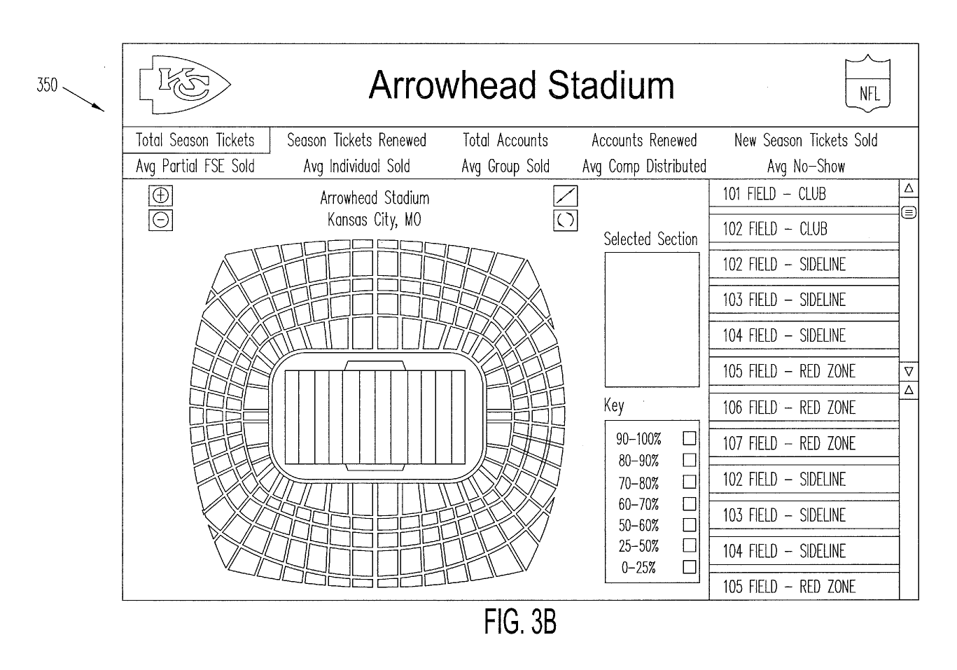

Turning next to FIGS. 3A-3B, screenshots of exemplary service provider pages depicting overhead graphical representations of venues for ticketed events of interest are provided. As shown in screenshot 300 in FIG. 3A, an overhead graphical representation of AT&T Park in San Francisco is provided. This can allow a user to more readily see a comprehensive map of the venue, so as to select a section or region of interest in a quick and efficient manner. Similarly, FIG. 3B provides a screenshot of an overhead map 350 of Arrowhead Stadium, which also allows a user to readily select a given section or region. Further actions, such as interactive three-dimensional rendering, based on these initial selections can then follow.

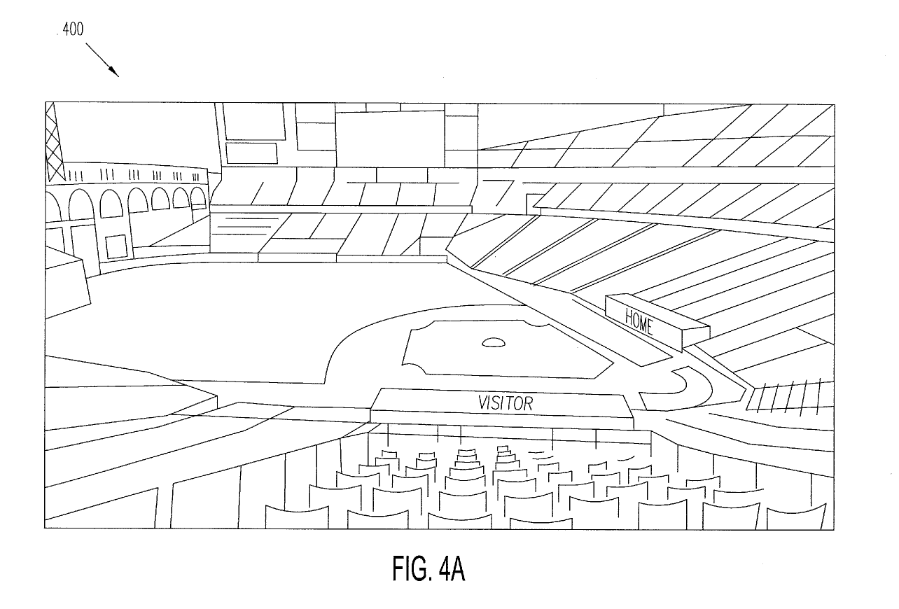

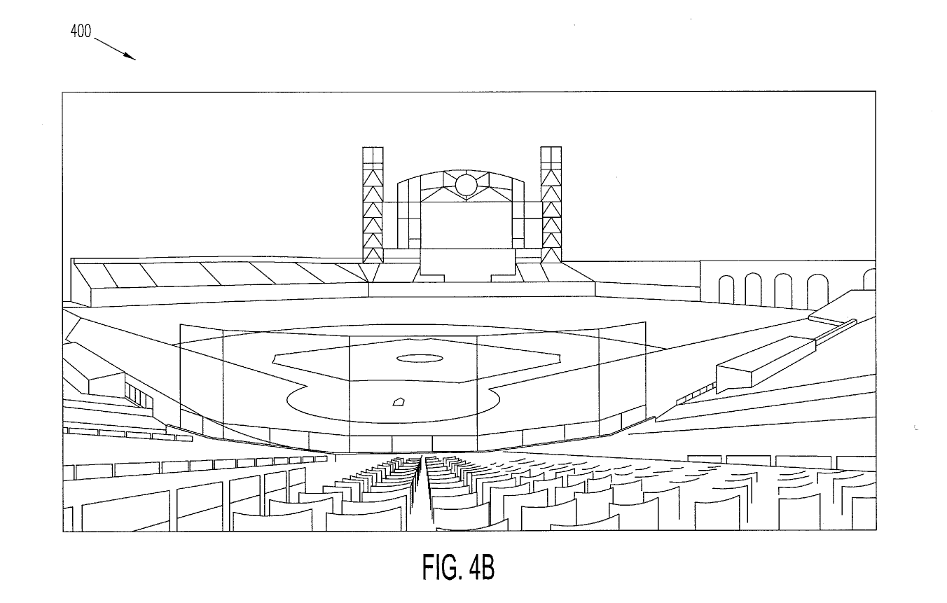

FIGS. 4A-4B illustrate screenshots of exemplary service provider pages depicting three-dimensional graphical representations of venues from particular seats for ticketed events of interests according to one embodiment of the present invention. Screenshots 400 and 450 depict baseball venues in a virtual three-dimensional manner from specific seat locations. It will be readily appreciated that the focus of the 3D views provided can be altered slightly as may be preferred by the user, and that the attendance location can be adjusted as well. For example, the “viewer” of screenshot 400 in FIG. 4A could select a seat location just a few seats to the right (toward home plate), and adjust the focus of the view toward the left field wall, upon which a new three-dimensional rendering and display would then be provided.

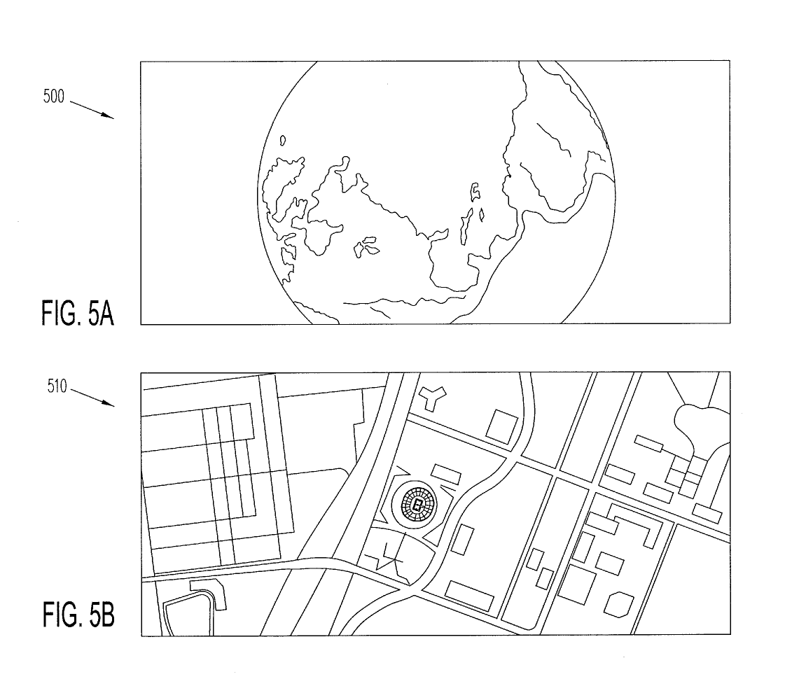

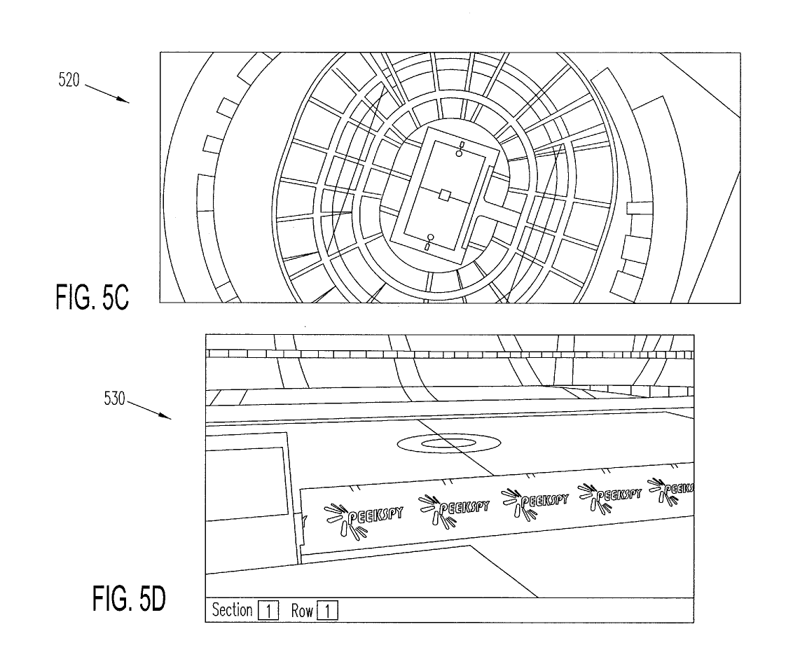

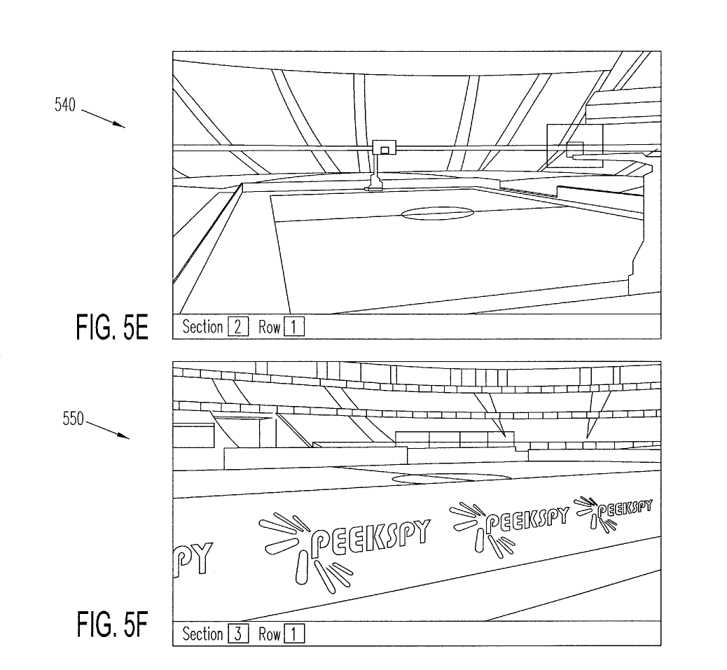

Moving now to FIGS. 5A-5F, a series of screenshots of exemplary service provider pages depicting graphical representations of a video progression using Google Earth are provided. Screenshots 500, 510 and 520 depict the progression of selecting and showing a selected venue with respect to a zoomed out global view to start. Once the venue has been isolated, such as in screenshot 520 in FIG. 5C, then various seat views therefrom for ticketed events of interests can be provided. For example, screenshot 530 depicts the view of a basketball court at the venue from several rows up behind the bench, while screenshot 540 depicts the view of the same court from courtside seats behind the baseline. Screenshot 550 then shows what the view of the same court looks like from the front row of the same section shown in screenshot 530.

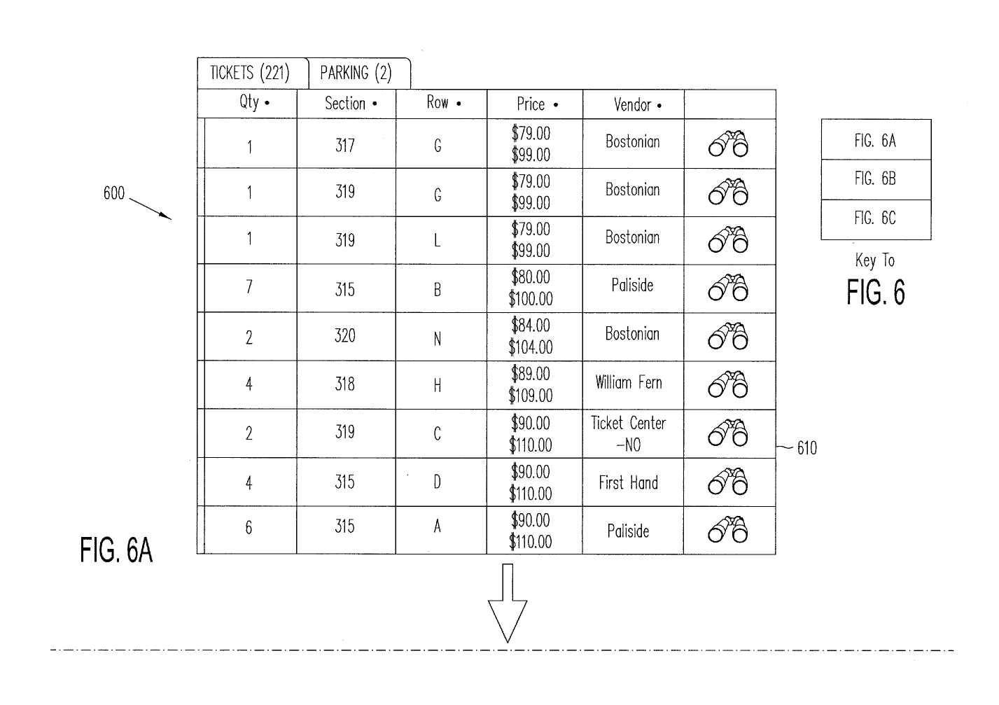

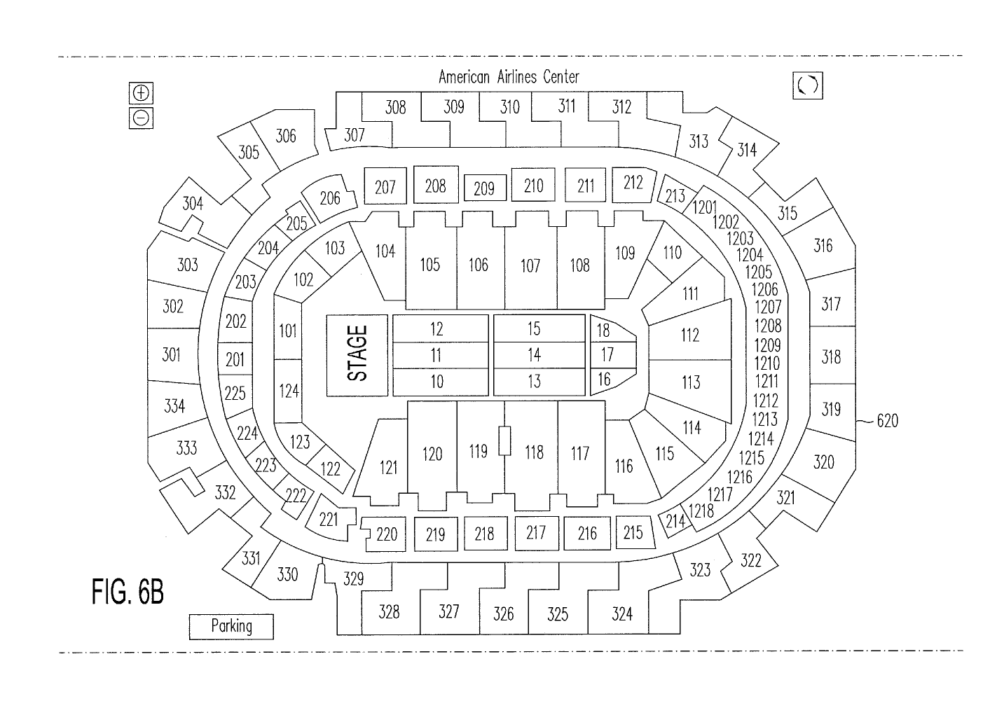

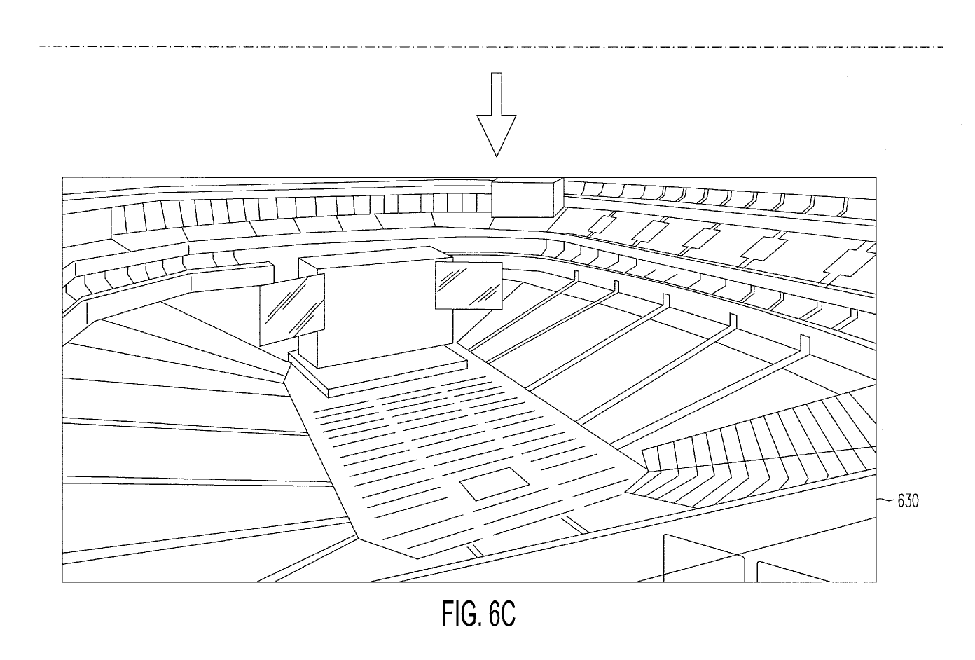

FIG. 6 illustrates screenshots of exemplary service provider pages depicting a progression for selecting tickets and displaying seat views for the selected seats for a ticketed event according to one embodiment of the present invention. Progression 600 can include a listing of available tickets 610, which can be linked to an overhead 2D map 620, which can both be linked to an interactive three-dimensional seat map interface and display 630. For example, a user may decide to select seats that are fairly inexpensive in Section 319 as shown in listing 610. The overhead 2D map 620 can then show where Section 319 is, while the interactive 3D map 630 can also show what the view looks like from that section.

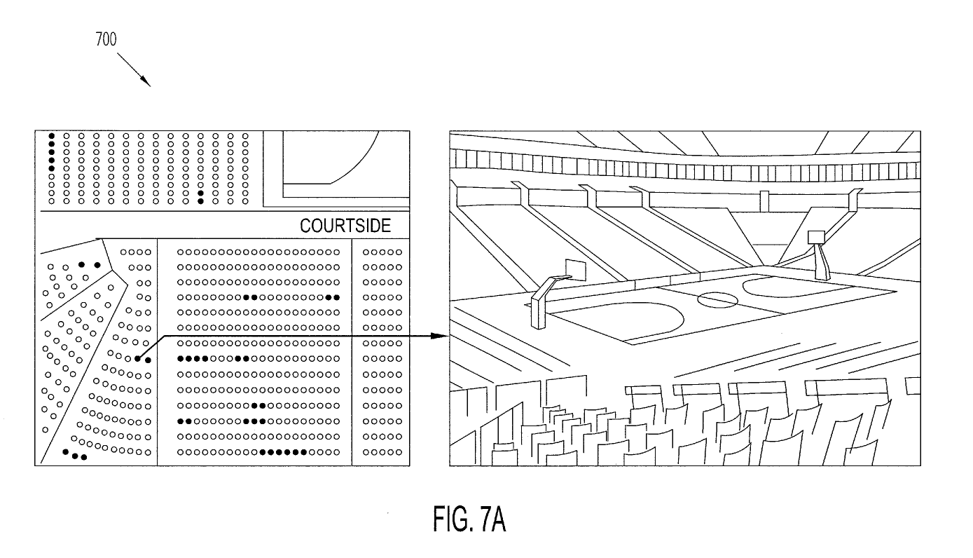

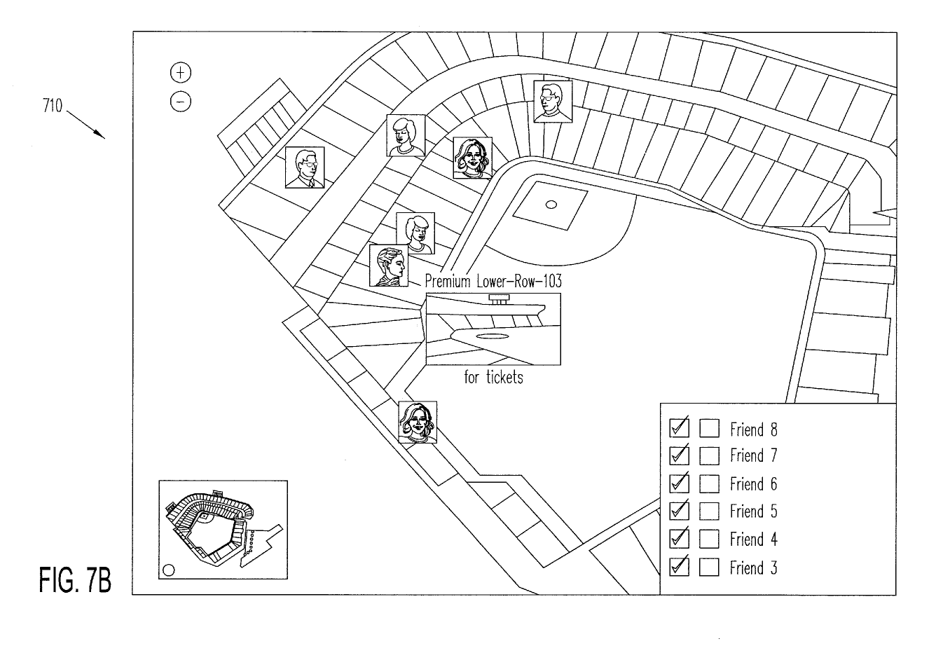

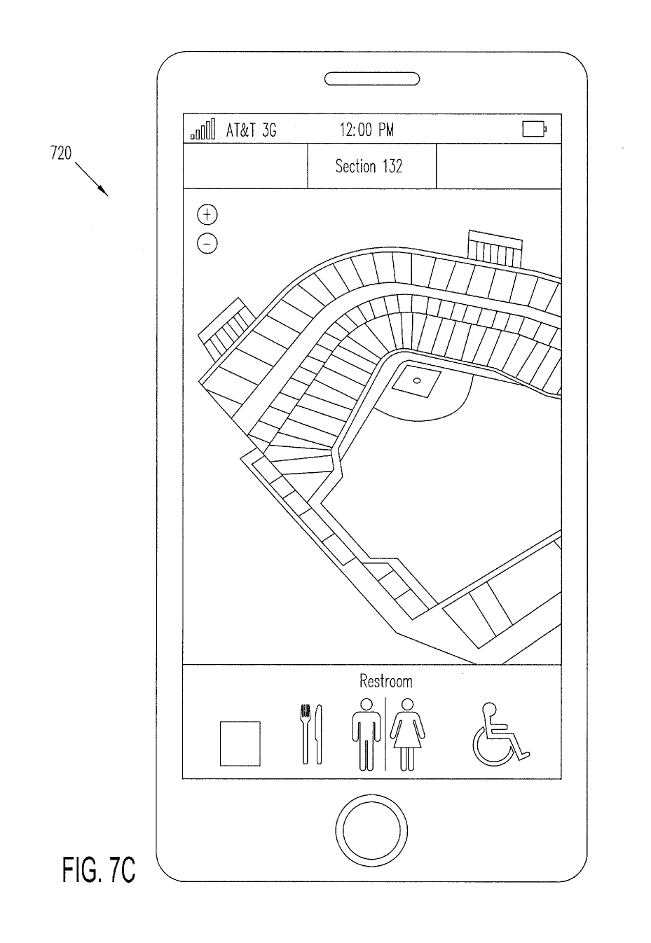

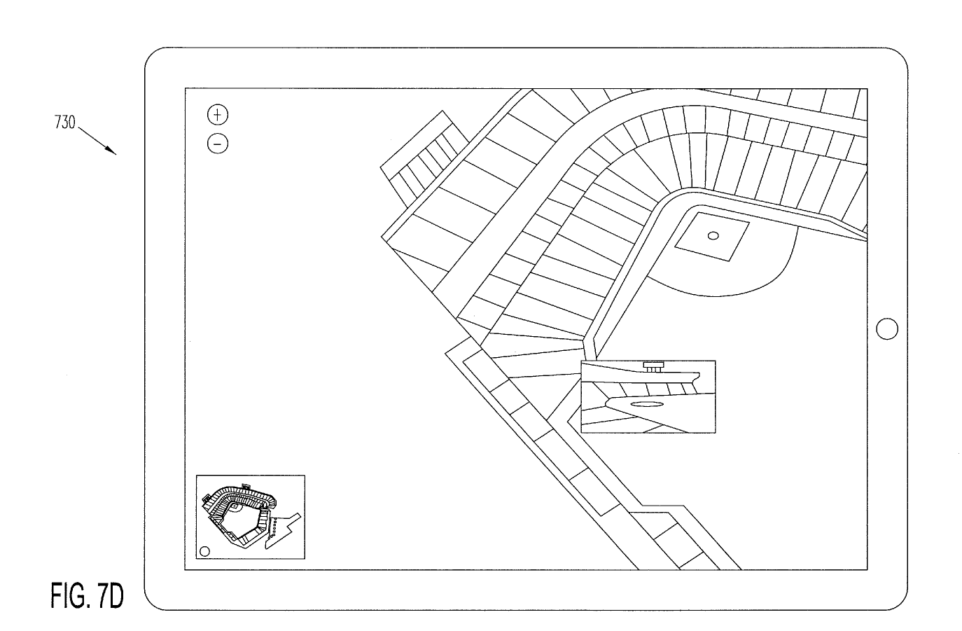

FIG. 7A illustrates screenshots of exemplary service provider pages depicting graphical representations of selected seats from overhead map and virtual three-dimensional views for ticketed events of interests. In this example, an overhead 2D map to the left of screenshot 700 can be linked directly to the interactive 3D view to the right. As shown, an arrow from two seats on the overhead map shows the exact seats from which the 3D view on the right is shown.

FIG. 7B illustrates a screenshot of an exemplary service provider page depicting a graphical representations of a venue and locations of friends or known persons at that venue according to one embodiment of the present invention. In addition to simply showing three-dimensional views from virtually every seat and most every angle, further interactive features can involve locating friends, family or other acquaintances or people at a given venue. As shown in screenshot 710, several people known to the user are attending an event at the venue. The user can then utilize the interactive 3D map to see what the views look like for each known person.

FIGS. 7C-7D illustrate representations of mobile devices depicting various screenshots of exemplary service provider pages that utilize map and virtual three-dimensional views according to one embodiment of the present invention. Mobile device 720 represents a smart phone, while mobile device 730 represents a tablet computing device. Of course, other devices such as laptop computers can similarly be used for such purposes.

### Methods

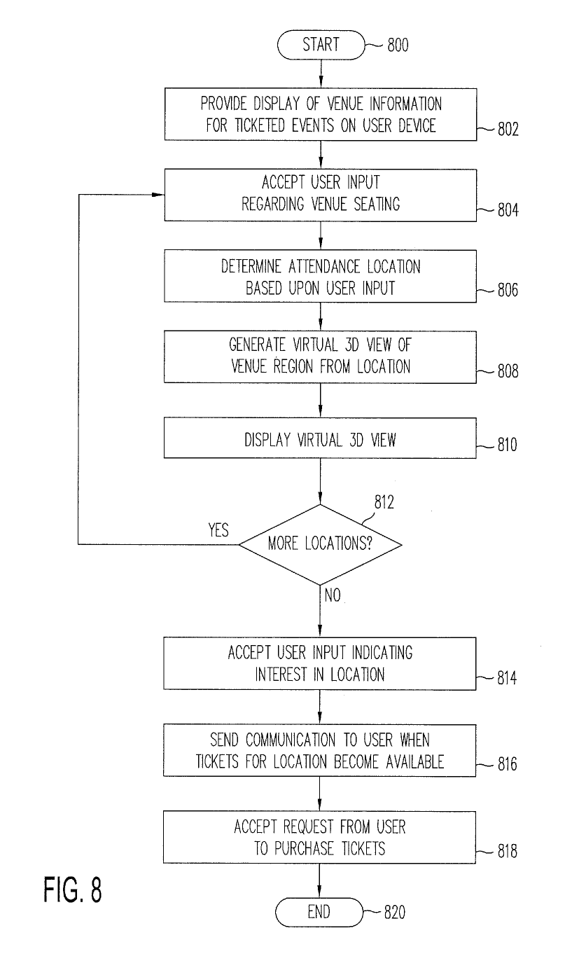

Although a wide variety of applications and methods involving the use of virtual three-dimensional interactive seat maps might be envisioned, one method is illustrated here. Turning lastly to FIG. 8, a flowchart of an exemplary method of facilitating a ticket selection for a ticketed event using a three-dimensional interactive seat map is provided. In particular, such a method can involve using or operating any of the various computing components, devices, systems and/or networks described above. It will be readily appreciated that not every method step set forth in this flowchart is always necessary, and that further steps not set forth herein may also be included. For example, additional steps can include suggesting ticketed events and accepting payments, among others. Furthermore, the exact order of steps may be altered as desired for various applications. For example, step 812 can be performed in a number of different locations in the process, such as after step 814. Further, steps 814 and 816 need not be performed in all cases, for example.

Beginning with a start step 800, venue information for ticketed events can be displayed on a user device at process step 802. A user input regarding selecting or designating one or more seat locations or other venue regions of interest is accepted at process step 804, after which an attendance location based upon the user input can be determined at process step 806. It will be understood that not every attendance location need be a seat, such as in the case of standing room only, pavilion, general admission and other non-seated ticket categories. Furthermore, some embodiments may permit a user to see virtual three-dimensional views from alternative locations, such as certain aisles, concourses, restrooms and concessions stands, for example.

At subsequent process step 808, a virtual three-dimensional or augmented reality view can be generated with respect to the determined location, upon which the view can be displayed at process step 810. This can include an overall view of the stage, playing field, court, rink, surface or the like, as well as zoomed views of different portions thereof. In addition, views from the determined location can also be made with respect to an orchestra pit, team benches, broadcasters, and other auxiliary locations of interest within the venue.

An inquiry can then be made at a decision step 812 as to whether more locations for views should be determined. This could involve, for example, a user deciding to see what the view at the venue looks like from different seats, rows or sections. Where such additional locations are to be input, the method reverts back to step 804, and the steps are then repeated through step 812. Once all locations have been determined though, then the method continues to process step 814.

At step 814, the user can indicate a particular interest in a given location at the venue. For example, the user can provide an input that he or she would like to be notified whenever tickets at a particular seat, row, section or the like become available for future ticketed event(s). An option could be provided for specific types of events or all events at that venue. At the following process step 816, a notice or other communication can be sent to the user when tickets at that location do become available for selection and/or sale. In some cases, steps 814 and 816 may not be used. A request from the user to purchase tickets can then take place at process step 818, after which the method finishes at end step 820. Further steps not depicted can include, for example, accepting switching between different venues, inquiring as to amenities such as concessions or restrooms with respect to a given attendance location. Other steps can include, for example, providing movie like views as the virtual location changes from one seat to another, as may be desired.

Although the foregoing invention has been described in detail by way of illustration and example for purposes of clarity and understanding, it will be recognized that the above described invention may be embodied in numerous other specific variations and embodiments without departing from the spirit or essential characteristics of the invention. Various changes and modifications may be practiced, and it is understood that the invention is not to be limited by the foregoing details, but rather is to be defined by the scope of the claims.

What is claimed is:

1. A computing system, comprising:
one or more memory device or storage components adapted to store event information regarding one or more upcoming ticketed events and venue information regarding seating arrangements and views from seats; and
one or more processors in communication with the one or more memory device or storage components and adapted to facilitate providing a display on a computing device to a user thereof, the display including information regarding a venue that is used for one or more ticketed events, accept from the computing device a first input from the user regarding seating arrangements for the venue, determine a first attendance location for a ticketed event at the venue based upon the first input, generate a first virtual three-dimensional or augmented reality view of a region of interest at the venue from the determined first attendance location, and display to the user the first virtual three-dimensional or augmented reality view on the computing device.

2. The computing system of claim 1, wherein the first virtual three-dimensional or augmented reality view is displayed on the same display component that displays the information regarding the venue.

3. The computing system of claim 1, further comprising a display component adapted to display to the user the first virtual three-dimensional or augmented reality view.

4. The computing system of claim 1, wherein said one or more processors are further adapted to accept a request to purchase tickets to the ticketed event from the user, wherein said request is based at least in part on the display of the first virtual three-dimensional or augmented reality view.

5. The computing system of claim I, wherein the attendance location is a specific seat at the venue selected by the user.

6. The computing system of claim 5, wherein the specific seat is selected while the user is physically at the selected seat.

7. The computing system of claim 1, wherein said one or more processors are further adapted to accept a second input from the user indicating a user interest in the determined first attendance location, and send a communication to the user at a later time when tickets at or near the determined first attendance location become available for purchase for another ticketed event at the venue.

8. The computing system of claim 1, wherein said one or more processors are further adapted to accept a second input from the user regarding alternative seating arrangements for the venue, determine a second attendance location for the ticketed event at the venue based upon the second input, generate a second virtual three-dimensional or augmented reality view of the region of interest at the venue from the determined second attendance location, and display to the user the second virtual three-dimensional or augmented reality view.

9. The computing system of claim 8, wherein said displaying involves a virtual reality transition from the first to the second virtual views.

10. A non-transitory medium having a plurality of machine-readable instructions which, when executed by one or more processors of a server controlled by a service provider, are adapted to cause the server to perform a method comprising:
facilitating a provision of a display on a computing device to a user thereof, the display including information regarding a venue that is used for one or more ticketed events, said providing being performed electronically by a processor;
accepting from the computing device a first input from the user regarding seating arrangements for the venue;
determining a first attendance location for a ticketed event at the venue based upon the first input;
facilitating the generation of a first virtual three-dimensional or augmented reality view of a region of interest at the venue from the determined first attendance location; and
communicating the display to the computing device the first virtual three-dimensional or augmented reality view.

11. The non-transitory medium of claim 10, wherein the method further comprises accepting from the computing device a request to purchase tickets to the ticketed event from the user, wherein said request is based at least in part on the display of the first virtual three-dimensional or augmented reality view.

12. The non-transitory medium of claim 10, wherein the attendance location is a specific seat at the venue selected by the user.

13. The non-transitory medium of claim 10, wherein the specific seat is selected while the user is physically at the selected seat.

14. The non-transitory medium of claim 10, wherein the method further comprises:
accepting from the computing device a second input from the user indicating a user interest in the determined first attendance location; and
sending a communication to the user at a later time when tickets at or near the determined first attendance location become available for purchase for another ticketed event at the venue.

15. A method of facilitating a ticket selection for a ticketed event, the method comprising:
providing a display on a computing device to a user thereof, the display including information regarding a venue that is used for one or more ticketed events, said providing being performed electronically by a processor;
accepting on the computing device a first input from the user regarding seating arrangements for the venue;
determining a first attendance location for a ticketed event at the venue based upon the first input;
generating a first virtual three-dimensional or augmented reality view of a region of interest at the venue from the determined first attendance location; and
displaying to the user the first virtual three-dimensional or augmented reality view.

16. The method of claim 15, further comprising accepting on the computing device a request to purchase tickets to the ticketed event from the user, wherein said request is based at least in part on the display of the first virtual three-dimensional or augmented reality view.

17. The method of claim 15, wherein the attendance location is a specific seat at the venue selected by the user.

18. The method of claim 17, wherein the specific seat is selected while the user is physically at the selected seat.

19. The method of claim 15, further comprising:
accepting on the computing device a second input from the user indicating a user interest in the determined first attendance location; and
sending a communication to the user at a later time when tickets at or near the determined first attendance location become available for purchase for another ticketed event at the venue.

20. The method of claim 15, further comprising:
accepting on the computing device a second input from the user regarding alternative seating arrangements for the venue;
determining a second attendance location for the ticketed event at the venue based upon the second input;
generating a second virtual three-dimensional or augmented reality view of the region of interest at the venue from the determined second attendance location; and
displaying to the user the second virtual three-dimensional or augmented reality view, wherein said displaying involves a virtual reality transition from the first to the second virtual views.
